(19) United States
(12) Patent Application Publication
(10) Pub. No.: US 2026/0205827 A1
(43) Pub. Date: Jul. 16, 2026

(54) COVERAGE ENHANCING DEVICE WITH VARIABLE GAIN

(71) Applicant: Sony Group Corporation, Tokyo (JP)

(72) Inventors: Olof ZANDER, Södra Sandby (SE); Kun ZHAO, Malmö (SE); Fredrik RUSEK, Eslöv (SE); Jose FLORDELIS, Lund (SE); Erik BENGTSSON, Eslöv (SE)

(21) Appl. No.: 19/135,775

(22) PCT Filed: Dec. 19, 2023
(86) PCT No.: PCT/EP2023/086704

§ 371 Date: Jun. 4, 2025

(30) Foreign Application Priority Data
Dec. 19, 2022 (SE) 2251490-5

(51) Int. Cl. H04W 16/26

(52) U.S. Cl. CPC H04W 16/26

(57) ABSTRACT

A coverage-enhancing device such as a network-controlled repeater is configured to set the gain by adjusting phase shift values of one or more phase shifters.

### TECHNICAL FIELD

Various examples of the disclosure generally pertain to coverage enhancing devices having variable gain. Various examples of the disclosure specifically pertain to coverage enhancing devices that include a fixed-gain amplifier and are configured to provide variable gain via adjustment of phase shift values at phase shifters of the coverage enhancing device.

### BACKGROUND

To increase a coverage area for wireless communication, it is envisioned to use coverage-enhancing devices (CEDs), such as Network Controlled Repeaters (NCRs) or re-configurable relaying devices (RRD). RRDs are sometimes also referred to as reflective intelligent surfaces. One example of RRDs are re-configurable reflective devices, sometimes also referred to as reflecting large intelligent surfaces (LISs). See, e.g., Huang, C., Zappone, A., Alexandropoulos, G. C., Debbah, M., & Yuen, C. (2019). Re-configurable intelligent surfaces for energy efficiency in wireless communication. IEEE Transactions on Wireless Communications, 18(8), 4157-4170. CEDs can also be referred to as network enhancement devices, since they generally enhance coverage, rank, and/or localizations.

An RRD may not possess the ability to provide a per-antenna gain; i.e., the antennas can be semi-passive and not amplify the antenna signal. The antennas may impose a variable phase shift but not a variable amplitude gain. Differently, at least in some scenarios the NCR is configured to impose a variable amplitude gain for each antenna element. A main differentiation between RRDs and NCRs relates to that in an NCR all signals received from the antenna elements of an antenna array are combined at some stage to form a single signal. Then they are re-distributed to the transmit antenna elements.

For a CED, an input spatial direction (or simply, input direction) from which incident signals on a radio link are accepted by the CED and an output spatial direction (or simply, output direction) into which the incident signals are redirected by the CED can be re-configured by changing a phase relationship (and, where possible, amplitude relationship) between the antennas (and—where available—the per-antenna variable amplitude gain). This corresponds to configuring a spatial filter at the CED. This corresponds to beamforming. An input beam and an output beam are defined. These beams have certain beam profiles.

### SUMMARY

A need exists for advanced techniques of operating CEDs. Specifically, a need exists for CEDs that can dynamically adjust the gain.

This need is met by the features of the independent claims. The features of the dependent claims define embodiments.

Various examples of the disclosure pertain to communicating between a transmitting communication device and a receiving communication device via a CED.

The transmitting communication device may be a base station (BS) of a cellular network, an access node of a communications network, or a wireless communication device (terminal; wireless transmit receive unit; UE). Likewise, the receiving communication device can be a BS of a cellular network, an access node of a communications network, or a UE.

According to examples of the disclosure, the CED is configured to provide a variable gain to the communication from the transmitting device to the receiving device. I.e., depending on the value of the gain provided by the CED, the signal level of signals received by the receiving communication device varies. The gain of the CED corresponds to the gain of a transmission line formed between input of the CED to output of the CED.

A CED includes an input antenna array. The input antenna array includes multiple first antenna elements and, for each one of the multiple first antenna elements, an associated first phase shifter. The CED also includes at least one fixed-gain power amplifier. The CED also includes an output antenna array. The output antenna array is coupled to the input antenna array via the at least one fixed-gain power amplifier. The output antenna array includes multiple second antenna elements and, for each one of the multiple second antenna elements, an associated second phase shifter. The CED also includes a control circuitry configured to control the first phase shifters and the second phase shifters to apply phase shift values. The control circuitry is configured to determine the phase shift values based on a value of a target gain.

A method of operating a CED includes obtaining a value of a target gain. The method also includes determining phase shift values depending on the value of the target gain and controlling phase shifters of at least one antenna array of the CED to apply the phase shift values.

The CED can be an NCR or an RRD or a reconfigurable reflective device.

By using a fixed-gain amplifier, the hardware implementation of the CED can be simplified (while maintaining the ability to dynamically set the gain). For instance, control signaling required for a variable-gain amplifier according to reference implementation can be omitted. This simplifies the control logic, as well as the hardware wiring required to control the variable gain amplifier.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 schematically illustrates a communication system according to various examples, the communication system including a BS, a UE and a CED.

FIG. 2 schematically illustrates the CED according to various examples.

FIG. 3 schematically illustrates a radiofrequency (RF) coupling between two antenna arrays of the CED according to various examples.

FIG. 4 schematically illustrates the UE and the BS of the communication system according to various examples.

FIG. 5 is a flowchart of a method according to various examples.

FIG. 6 schematically illustrates beam profiles defined by different phase shift values according to various examples, the beam profiles providing different values of a target gain for communicating via the CED.

FIG. 7 illustrates a beam profile of a waste beam according to various examples.

FIG. 8 illustrates the beam profile of a waste beam according to various examples.

FIG. 9 illustrates the beam profile of a waste beam according to various examples.

FIG. 10 schematically illustrates beam profiles defined by different phase shift values according to various examples, the beam profiles providing different values of a target gain for communicating via the CED.

FIG. 11 schematically illustrates an implementation of the CED as reconfigurable reflective device according to various examples.

FIG. 12 schematically illustrates an implementation of the CED as reconfigurable reflective device according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various examples of the disclosure pertain to a CED. Various examples pertain to an active CED that is configured to provide power amplification. The CED includes a fixed-gain power amplifier. The fixed-gain power amplifier amplifies an RF signal. Such fixed-gain power amplifier is not capable of actively changing its gain, e.g., depending on an external setpoint signal (for large input signals, saturation may be reached). The fixed-gain power amplifier is, accordingly, different than a variable-gain power amplifier. A variable gain power amplifier normally includes a variable RF damper or a tunable RF bias or RF switching among different gain stages.

According to various examples, the CED is configured to provide a variable gain.

A possible definition of the gain of the CED (e.g., a RIS) is provided next. Let one, arbitrarily selected, antenna element at the CED act as a reference antenna element. Let P0 denote the squared magnitude of the product of the radio channel from a reference transmitting antenna element of a transmitting communication device to the CED reference antenna element and the radio channel from the CED reference antenna element to a reference receiving antenna element of a receiving communication device. Let P1 denote the squared magnitude of the sum of products of the radio channel from the reference transmitting antenna element to CED antenna element k, the processing at CED antenna element k, and the radio channel from CED antenna element k to the reference receiving antenna element. Then the gain of the CED can be defined as P1/P0.

According to various examples, phase shift values at phase shifters associated with antenna elements of the CED are sub-optimally chosen, i.e., below a value that would provide maximum gain for the communication from a transmitting device to a receiving device.

The phase shift values are determined based on a value of the target gain. The value of the target gain can be externally set. The value of the target gain can be dynamically set, i.e., updated from time to time while operating the CED. Responsive to such updates of the value of the target gain, the phase shift values are re-determined and adjusted.

These techniques are based on the following findings: conventionally the phase shift values are determined in accordance with a selected spatial filter to be provided by the CED. For example, the phase shift values would be determined based on a target input direction and a target output direction. The selection of a given input beam and a given output beam—typically based on the position of a transmitting device and a receiving device—in other words, according to reference scenarios, is a sufficient prerequisite to determine the phase shift values. The phase shift values {αₙ}—according to reference implements—are selected so beamforming towards the transmitting device is obtained; and the phase shift values {βₘ} so that beamforming towards the receiving device is obtained.

Differently, according to the disclosed techniques, the selection of a given input beam and a given output beam is not a sufficient prerequisite for determining the phase shift values; this is because the value of the target gain is used to determine the phase shift values.

With optimally selected phase shift values maximizing the gain, the input antenna array and the output antenna array can generate array gains of N and M, respectively. However, if the phase shift values of phase shifters of the input antenna array and/or phase shifters of the output antenna array are sub-optimally selected, it is possible to create arbitrary array gains strictly less than N and M. In particular, the array gains can be set to match a value of a target gain.

By determining the phase shift values also depending on the value of the target gain, it is possible to synthesize a variable gain amplifier. At the same time, complex wiring and complex control logic as would be required for a legacy variable gain amplifier can be dispensed with. This simplifies the overall operation of the CED. Furthermore, the amplifier can be protected from large signals, e.g., if a transmitter is located very close to the CED (where otherwise saturation or even damage to the amplifier would be observed).

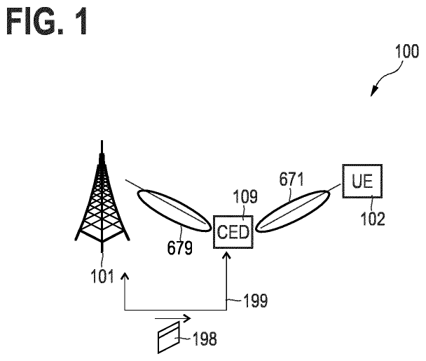

FIG. 1 illustrates an example communication system 100 that includes a CED 109 and a BS 101 as well as a UE 102. Illustrated is a beam 679 used by the CED 109 by appropriate beamforming to communicate with the BS 101. Also illustrated is a beam 671 used by the CED 109 to communicate with the UE 102.

As a general rule, communication can be in uplink direction, i.e., from the UE 102 to the BS 101. In this scenario, the UE 102 is the transmitting device and the BS 101 is the receiving device.

The beam 671 in this scenario is an input beam oriented along an input direction; while the beam 679 is an output beam oriented along an output direction.

It would also be possible to implement downlink communication from the BS 101 to the UE 102. In this scenario the BS 101 is the transmitting device and the UE 102 is the receiving device.

The beam 679 is the input beam oriented along the input direction; while the beam 671 is the output beam oriented along the output direction.

For the sake of simplicity, hereinafter, scenarios will be described with respect to downlink communication; however, similar scenarios may be readily applied to uplink communication from the UE 102 to the BS 101, or sidelink communication between two UEs.

The respective orientations of the beam 671, 679—i.e., the target input and output directions—can be determined as part of beam sweeps using reference techniques available in the prior art. Also illustrated is a control link 199 between the BS 101 and the CED 109. The BS 101 can control the CED 109 via the control link 199. For instance, the BS 101 could provide one or more control messages 198 to the CED 109, the one or more control messages 198 being indicative of at least one of a value of a target gain, a value of a target input direction or a value of a target output direction.

It is not required in all scenarios that the BS 101 implements the control node of the CED 109. In other scenarios, another node of the cellular network to which the BS 101 belongs can implement control functionality for the CED 109. For example, a UE 102 may alternatively or additionally implement control functionality for the CED 109. Also, a dedicated control node may be provisioned.

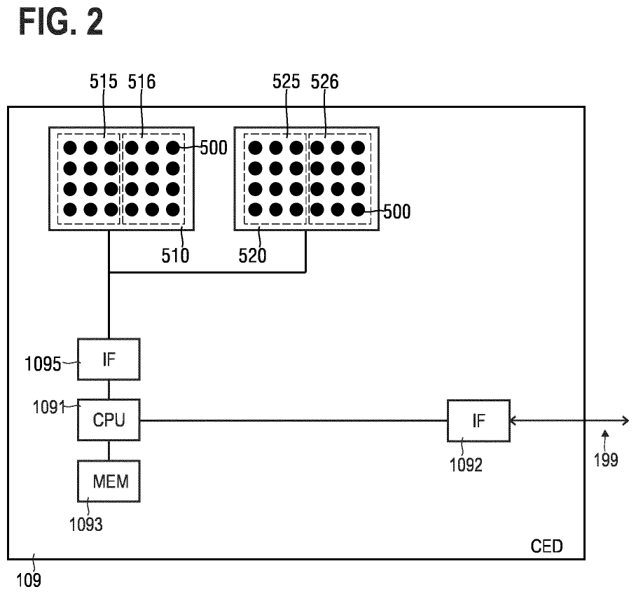

FIG. 2 schematically illustrates aspects with respect to the CED 109. The CED 109 includes two antenna arrays 510, 520, each antenna array including multiple antenna elements 500 (the antenna elements 500 are marked with full circles in FIG. 2).

The antenna array 510 implements an input antenna array; i.e., phase shift values of the antenna elements 500 (or simply antennas) of the input antenna array 510 can be determined based on a value of an input direction. These phase shift values can be determined to form the input beam 679 (cf. FIG. 1).

The antenna array 520 implements the output antenna array. The phase shift values of phase shifters associated with the antenna elements 500 of the output antenna array 520 (the phase shifters are not shown in FIG. 2) can be set to implement phase shift values that form the output beam 671 (cf. FIG. 1).

In some examples the CED 109 is implemented by a reconfigurable reflective device; here, a single antenna array is used to provide reflection of incident electromagnetic signals at its antenna elements. Thus, in some scenarios, the input antenna array and the output antenna array are implemented by shared antenna elements (not shown in FIG. 2).

The phase shift values of the phase shifters associated with the antenna elements can be reconfigured by a processor 1091. For this, the processor 1091 can provide respective re-configuration commands via a communication interface 1095 to the antenna arrays 510, 520. For this, the processor 1091 can load program code from a memory 1093 and execute the program code and then based on the program code reconfigure the phase shift values. Also, if a variable gain can be applied per antenna, this can be re-configured by the processor 1091.

Accordingly, the processor 1091 and the memory 1093 form a control circuitry of the CED 109. As illustrated in FIG. 2 it would be possible that each antenna array 510, 520 is partitioned into respective subarrays 515, 516, 525, 526. Then beam-splitting can be applied at the partitioned antenna array 510, 520 where different beams are formed at each subarray 515, 516, 525, 526. Executing the program code causes the processor 1091 to perform techniques as described herein, e.g., obtaining at least one control message, e.g., via the communications interface 1092 on the control link 199, the at least one control message being indicative of at least one of a value of a target gain, a value of the target input direction or a value of a target output direction; determining phase shift values for phase shifters associated with the antenna elements 500 based on one or more criteria; re-configuring phase shifters in accordance with the phase shift values; re-configuring variable gain amplifiers of each antenna element in accordance with gain values determined for beamforming; etc.

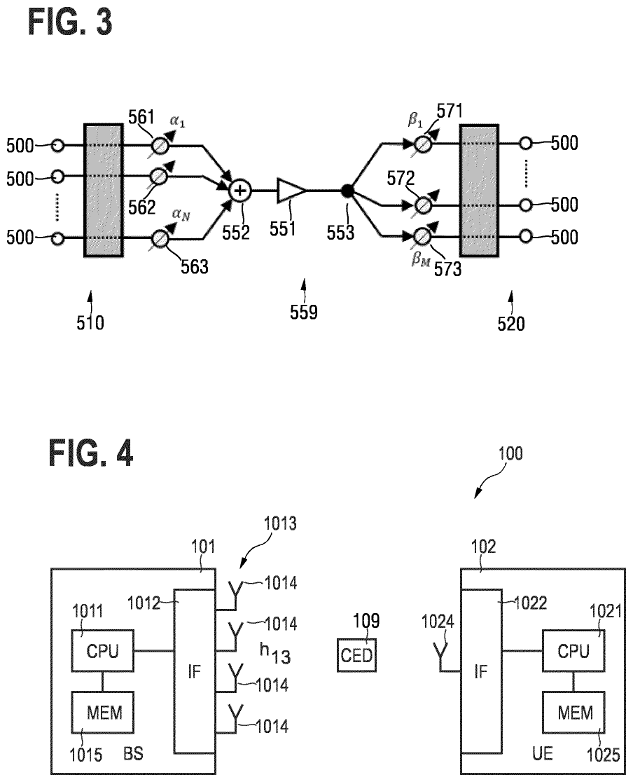

While FIG. 2 illustrates the control signaling used to control the antenna arrays 510, 520, it does not show the radio frequency components and a radiofrequency coupling between the antenna arrays 510, 520. This is illustrated in FIG. 3.

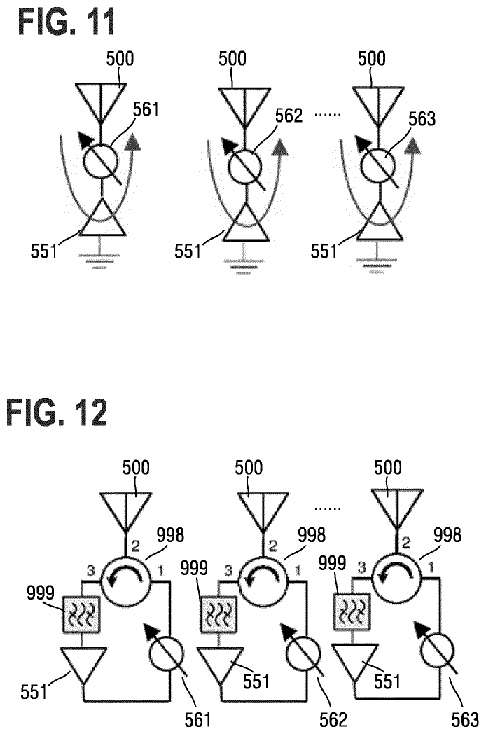

Also, while FIG. 2 illustrates two separate antenna array 510, 520 for input and output, a reflective configuration can employ a single antenna array for input and output (cf. FIG. 11 and FIG. 12).

FIG. 3 illustrates aspects with respect to a radiofrequency (RF) coupling 559 between the antenna array 510 and the antenna array 520.

In FIG. 3 the input antenna array 510 includes the antenna elements 500; each antenna element 500 is associated with a respective phase shifter 561, 562, 563 that applies respective phase shift values (labeled alpha). The phase shifter signals are then combined in a combining node 552 (this corresponds to an NCR implementation of the CED 109); then, there is provisioned a fixed-gain amplifier 551. The amplified signal is then split at node 553 and forwarded to phase shifters 571, 572, 573 associated with the antenna elements 500 of the output antenna array 520.

In some examples, it would be possible that each antenna element 500 of the input antenna array 510 and/or the output antenna array 520 is associated with a respective per-antenna variable-gain amplifier. With individual variable power amplifiers per antenna, the beamforming can accomplish more effects than only power gains. For example, wide beams, advanced beam-splits, etc. The gain ratio between the antenna array (also referred to as panels) can be altered synchronously with the time division duplex direction (i.e., as input and output antenna array is swapped); it would even be possible have different total gain for UL vs. DL.

The radiofrequency coupling of FIG. 3 is unidirectional. For bidirectional communication, the radiofrequency coupling 559 can be duplicated. Also, time-division duplex operation would be possible.

FIG. 4 illustrates aspects related to the BS 101 and the UE 102.

The BS 101 includes a processor 1011 that can load program code from a memory 1015 and execute the program code. Executing the program code can cause the processor 1011 to perform techniques here as described herein, e.g.: configuring the CED 109, e.g., with a value of a target gain, using a respective control message; transmitting signals towards the CED 109; using beamforming to direct signals towards the CED 109, e.g., using polarization multiplexing (illustrated this respective communication interface 1012 and an antenna array 1013 including multiple antennas 1014); etc.

FIG. 4 illustrates details with respect to the UE 102. The UE 102 includes a processor 1021 and a memory 1025. The processor 1021 can load program code from the memory 1025 and execute the program code. Upon executing the program code, the processor can perform techniques as disclosed herein: e.g., receiving or transmitting signals via a wireless communication interface 1022 that accesses one or more antennas 1024; etc.

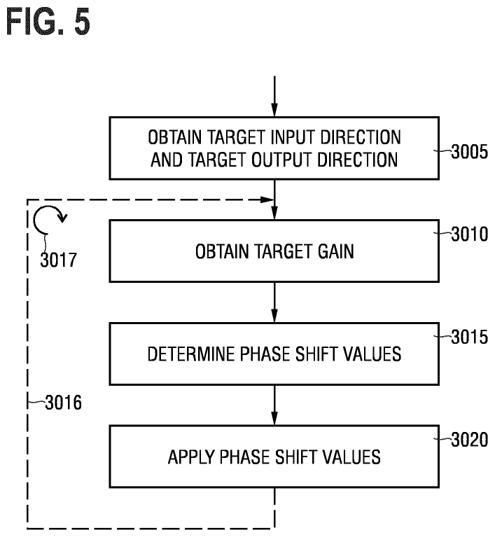

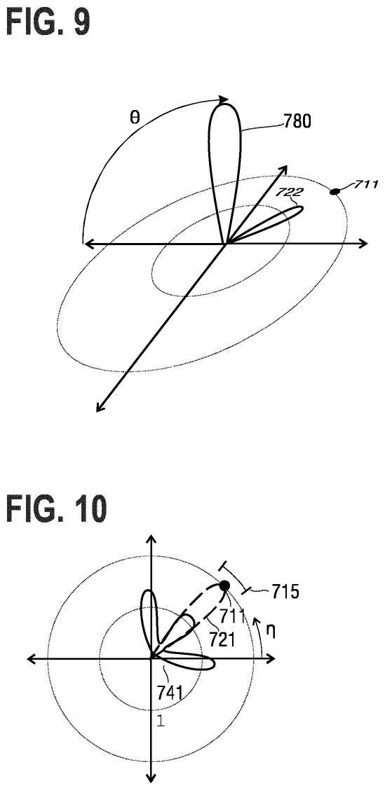

FIG. 5 is a flowchart of a method according to various examples. The method of FIG. 5 corresponds to operation of a CED such as the CED 109. The method of FIG. 5 can be executed in a CED of a communication system that includes a transmitting device and a receiving device. The method of FIG. 9 corresponds to applying a variable gain at the CED, in accordance with a value of a target gain.

The method of FIG. 5 can be executed by a control circuitry of the CED. For instance, the method of FIG. 5 can be executed by the processor 1091 of the CED 109 upon loading program code from the memory 1093 and upon executing that program code.

At box 3005, a value of a target input direction and the value of a target output direction are obtained.

Box 3005 can include loading the value of the target input direction and/or the target output direction from a local memory. It would also be possible that box 3005 includes obtaining a respective control message that is indicative of the value of the target input direction and/or the target output direction, e.g., from a BS of a cellular network or another control node.

For instance, a certain beam identity may be indicated by a control message that is received; the beam identity defines an input beam or an output beam. This beam identity then defines a given value of the target input direction, because the beam is aligned accordingly. The beam identity of the beam can then be mapped to certain phase shift values of the phase shifters associated with the antenna elements of the respective antenna array, through a codebook (note that the codebook can include multiple options per beam identity, for different values of the target gain, as will be explained later), as will be explained later in connection with box 3015. It would also be possible that the value of the target input direction expresses the orientation of the input beam in explicit terms. The value of the target input and/or output direction could be indicative of an azimuth angle and an elevation angle. Then, using conventional beamforming strategies, the phase shift values can be calculated (non-codebook approach) at box 3015.

At box 3010, a value of the target gain is obtained. For example, a control message can be obtained that is indicative, explicitly or implicitly, of the value of the target gain. The control message can, accordingly, configure the target gain to be achieved by operation of the CED.

For instance, the control message could be indicative of a certain dB value. The control message could include a multibit indicator in accordance with a predetermined mapping.

A control message received at box 3010 that is indicative of the value of the target gain can include multiple information elements so that both the value of the target gain is accommodated in the control message, as well as the value of the target input direction and/or the value of the target output direction of box 3005.

At box 3015, phase shift values are determined for phase shifters associated with antenna elements of an input antenna array of the CED as well as for phase shifts associated with antenna elements of an output antenna array of the CED.

The phase shift values are determined based on the value of the target gain obtained at box 3010. This means that by determining the phase shift values, the gain of the CED can be tuned. The phase shift values as determined at box 3015 are then applied at box 3020. Phase shifters are re-configured accordingly (cf. FIG. 2).

This behavior is further exemplified by the optional loop 3016 in FIG. 5. As illustrated by the loop 3016, it is possible that the CED, upon determining the phase shift values at box 3015, obtains a new value of the target gain at a further iteration 3017 of box 3010; while the value of the target input direction as well as the value of the output direction—as previously obtained at box 3005—remain the same. In such a scenario, even though the target input direction value as well as the target output direction value remain the same, the phase shift values are re-determined at box 3015. The phase shift values determined at the second iteration 3017 of box 3015 then differ from the phase shift values determined at the first iteration 3017 of box 3015, due to the difference in the target gain values obtained at the different iterations of box 3010.

In other words, by executing multiple iterations 3017, the phase shift values are repeatedly determined responsive to obtaining new values for the target gain, e.g., by receiving multiple in-stances of a respective control message that is indicative of an update of the value of the target gain. Such approaches enable a dynamic adjustment of the gain provided by the CEO over the course of time.

As a general rule, the gain provided by the CEO for a communication from a transmitting communication device to a receiving communication device can be adjusted by adjusting the phase shift values of phase shifters of an input antenna array and/or the phase shift values of phase shifters of an output antenna array. See TAB. 1.

TABLE 1
Various options for considering the value of the target gain when determining phase shift
values. From a signal-to-noise ratio perspective, option 2 can be preferred; on the
other hand, if the input signal-to-noise ratio is high, then option 1 or option 3 may
be the preferred option, because less power is then required at the fixed-gain amplifier
of the CED. While in option 3 all phase shift values will be impacted by the value of
the target gain, in options 1 and 2 only some phase shift values will be impacted.

| | | Consider target | |
|---|---|---|---|
| | Consider target gain | gain value for | |
| | value for phase shift | phase shift values | |
| | values at input an- | at output antenna | |
| OPTION | tenna array | array | |
| 1 | YES | NO | The phase shift values of the |
| | | | phase shifters associated with |
| | | | the antenna elements of the input |
| | | | antenna array are determined |
| | | | based on the value of the target |
| | | | gain; while the value of the target |
| | | | gain is not considered when |
| | | | determining the phase shift values |
| | | | of the phase shifters associated |
| | | | with the antenna elements of the |
| | | | output antenna array. |
| 2 | NO | YES | The phase shift values of the |
| | | | phase shifters associated with |
| | | | the antenna elements of the output |
| | | | antenna array are determined |
| | | | based on the value of the target |
| | | | gain; while the value of the target |
| | | | gain is not considered when |
| | | | determining the phase shift values |
| | | | of the phase shifters associated |
| | | | with the antenna elements of the |
| | | | input antenna array. |
| 3 | YES | YES | Both the phase shift values of the |
| | | | phase shifters associated with |
| | | | the antenna elements of the input |
| | | | antenna array as well as the |
| | | | phase shift values of the phase |
| | | | shifters associated with the |
| | | | antenna elements of the output |
| | | | antenna array are determined |
| | | | based on the value of the target |
| | | | gain. |

Then, within each of the options in TAB 1, there are again certain options on how to determine the respective phase shift values, i.e., how to consider the value of the target gain when determining the phase shift values. Some of these options are discussed next in connecting with the following figures.

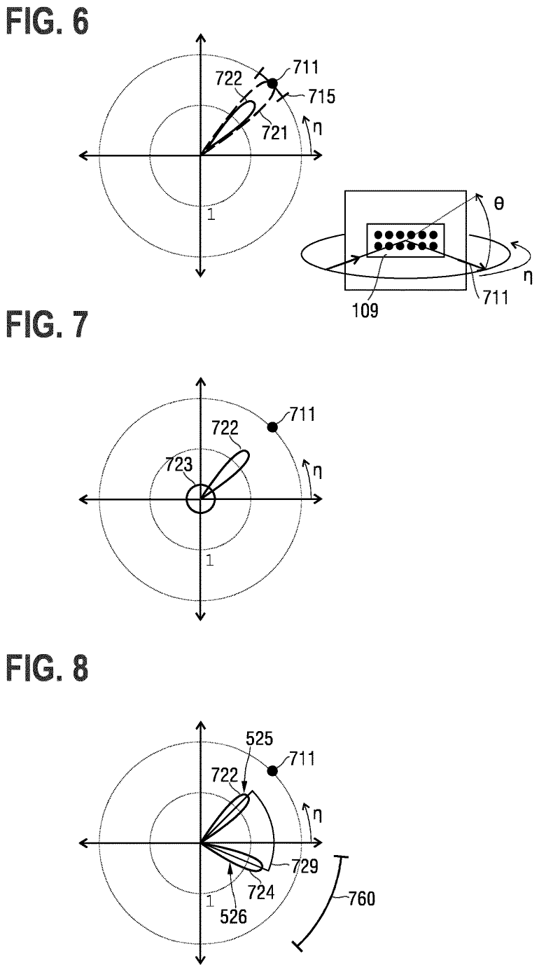

FIG. 6 is a polar plot of the profile of beams 721, 722. Thus, the beam profile is graphically illustrated. The beam profile is generally defined by the orientation and shape (e.g., beam width, number of side lobes, number of peaks, etc.) of the respective beam. The angular position of the polar plot encodes the orientation of the beams. Specifically, in the illustrated example the lateral orientation (in a predetermined plane, in typical deployment scenarios of the CED enclosing no or only a small angle with the horizontal plane) is encoded.

FIG. 6 resolves the azimuthal position η. For instance, for a wall-mounted CED, the polar plot of FIG. 6 would resolve all orientations in a horizontal plane (cf. inset of FIG. 6; where the antenna arrays extend in the vertical plane along the wall).

For example, beams 721, 722 could be input beams formed by the input antenna array (cf. TAB. 1: option 1) or could be output beams formed by the output antenna array (cf. TAB. 1: option 2). It would also be possible that input and output beams are similarly affected as illustrated in FIG. 6 (cf. TAB. 1: option 3).

For the sake of simplicity, it is now assumed that the beams 721, 722 are output beams. This means that the radius of the polar plot encodes a radiated power per solid angle (for input beams, a received power/sensitivity per solid angle would be encoded for input beams). This means that larger radiated power corresponds to a radial position at a larger distance to the center of the polar plot.

The absolute numbers of the radiated power are not germane; arbitrary units are plotted. Nonetheless, it should be understood that since a fixed-gain amplifier is used to amplify the received signals, it is possible that the overall value of the target gain that is achieved is larger than 1. I.e., the CED can provide signal amplification.

Both output beams 721, 722 are centered at a certain output direction 711. The output direction 711 can be specified by the value of the target output direction (cf. box 3005). They also have the same beam width 715 (accordingly, the gain is not affected by a change of the beam width). Thus, both beams 721, 722 are pencil beams directed so that the receiving communication device can be served.

The output beam 721 has a larger radiated power (e.g., effective isotropic radiated power, EIRP) along the output direction 711 than the output beam 722. (Similarly, it is possible that for input beams the two input beams have the same received power along the respective input direction, e.g., the same equivalent isotropic sensitivity, EIS).

The output beam 722 is used for a large value of the target gain and the output beam 722 is used for a small value of the target gain (e.g., in different iterations 3017 of the method of FIG. 5).

For example, it would be possible that the output beam 721 corresponds to an optimum of the phase shift values. I.e., the maximum array gain may be achieved by the output beam 721. The value of the target gain achievable by the output beam 721 can equate to a nominal gain value associated with the array gain associated with the input antenna array, the array gain associated with the output antenna array as well as the gain of the fixed-gain amplifier. The value of the target gain achievable by the output beam 722 is below this nominal gain value. It may still equate to a target gain that is larger than 1 for the CED.

There are different options available to determine the phase shift values of the phase shift is associated with the antenna elements of the output antenna array to selectively implement either the output beam 721 or the output beam 722, depending on the value of the target gain.

For example, beam splitting can be used. For example, it is possible to partition the output antenna array into two or more subarrays for forming the beam 722 (cf. FIG. 2: subarrays 525, 526). A first subarray is then used to form the output beam 721 and a second subarray is used to form another beam offset from the output beam 722. I.e., the radiated power is split between the two output beams 721, 722. Conversely, the entire output antenna array is used to form the beam 721.

Because only a smaller number of antenna elements participate in forming the beam 722 if compared to the number of antenna elements forming the beam 721, the radiated power of the beam 722 is smaller than the radiated power of the beam 721.

Accordingly, in some scenarios it is possible that the number of antenna elements assigned to the subarrays is determined based on the target gain.

Typically, the count of antenna elements is significant, e.g., larger than 50 or larger than 500 or even larger than 5000. By increasing or decreasing the count of antenna elements included in the subarray forming the beam that serves the receiving communication device, the gain of the CED can be increased or decreased, respectively. The increment with which the gain can be adjusted in such scenario corresponds to the impact of a single antenna element; this impact is comparatively small for a large total count of antenna elements in the output antenna array. This allows fine adjustment of the gain of the CED. Even finer adjustment of the gain can be achieved where the phase shift values of individual antenna elements of a given subset are (de-)tuned.

Alternatively or additionally to such dependency of the partitioning of the output antenna array on the value of the target gain, it would also be possible that the relative arrangement of the subarrays depends on the value of the target gain. For example, in one scenario the subarrays are arranged offset from each other (such a scenario is illustrated in connection with FIG. 2 for the subarrays 515, 516 of the input antenna array 510 and the subarrays 525, 526 for the output antenna array 520, respectively). In another scenario, the antenna elements assigned to different ones of the two or more subarrays are arranged in an interleaved manner. This would mean that neighboring antenna elements can be alternatingly assigned to different subarrays. I.e., the subarrays can be overlapping.

By such strategies of forming the subarrays, tailored properties for the beam 722 formed by a given subarray and aligned with the output direction 711 that is associated with the receiving communication device as well as for one or more other beams formed by the further subarrays of the partitioned output antenna array can be achieved. Such other beam(s)—different than the beam 722—can be called “waste beam” (the waste beam is not shown in FIG. 6). This is because the waste beam is not used to enable communication between the transmitter and the receiver device.

On the other hand, by using the waste beam, the total radiated power (TRP) may remain unaffected by the specific value of the target gain. In other words, the TRP (integrated across all solid angles) for only using the output beam 721 can be the same as the total radiated power for using the output beam 722 plus one or more waste beams. Such a scenario has the advantage that power is not dissipated within the CED so as to avoid heating.

There are different options available for implementing the waste beam.

A first option is illustrated in FIG. 7 (the polar plot of FIG. 7 corresponds to the polar plot of FIG. 6). Here, the waste beam 723 has an omnidirectional beam profile. This can be achieved by using randomized phase shift values at the respective subarray. In such a scenario, it is particular helpful if the two subarrays used for forming the beams 722 and 723 respectively are interleaved. For instance, it would be possible that antenna elements are alternatingly assigned to the two subarrays, i.e., n-th antenna element can be associated with a randomized phase shift value, wherein n is smaller for smaller values of the target gain.

A second option is illustrated in FIG. 8 (the polar plot of FIG. 8 corresponds to the polar plot of FIG. 6). Here, the waste beam 724 has a directional beam pattern, i.e., a pencil beam is used. The beam 724 is offset from the beam 722 by a certain offset angle 729.

This offset angle 729 may be independent of the value of the target gain. In other words, it would be possible that irrespective of the specific radiated power of the beam 722 the offset angle 729 remains the same. Thus, a reduction of the target gain is not achieved by tilting a beam away from the desired value of the target direction, because such approach would result in higher interference.

Rather, while the beam 722 is aligned with the target output direction 711, the waste beam 724 is rather aligned with a target area 760. The target area 760 is known to cause low or no interference to other communication devices in the vicinity of the CED. For instance, the target area 760 can be configured by a control node of the CED, e.g., by a BS. Other considerations (beyond low interference) can be used to determine the target are 760.

In yet another scenario, it would also be possible that the waste beam is inclined with respect to the beam 722, out of the azimuthal plane illustrated in the polar plots of FIG. 6-FIG. 8. In particular, the waste beam can have an elevation angle θ outside of −75 degrees to +75 degrees (wherein 0 degree is in the plane illustrated by the polar plots of FIGS. 6 through 8). This is illustrated in FIG. 9 for the waste beam 780.

In the scenario of FIG. 9 it is possible that the total radiated power is different when using the output beam 722 and the output beam 780, if compared to when using only the output beam 721 (cf. FIG. 6). This is because the antenna elements of the output antenna array may be arranged in the plane of the beam 780, such that energy does not coherently add in the far field and thus not all power is radiated. Then the total radiated power is reduced. This limits interference to other devices.

Above, in connection with FIGS. 6 through 9, scenarios have been illustrated in which the output antenna array is partitioned into subarrays. It would also be possible to adjust the phase shift values coherently across all antenna elements of the output antenna array. I.e., beam-splitting is not used. Such a scenario is illustrated in FIG. 10 (the polar plot of FIG. 10 corresponds to the polar plot of FIG. 6). Here, while the beam 711 has a single peak, the beam 741 has three peaks (one center peak that is aligned with the target output direction 711 and the output beam 721, and two side peaks/sidelobes). The radiated power of the beam 741 along the target output direction 711 is smaller than the radiated power of the beam 721. This is achieved by increasing the number of peaks. For example, the count of peaks can increase for smaller values of the target gain.

Above, in connection with FIG. 6 through FIG. 10, various options for determining beams 721-724, 741, 780 that enable to achieve a certain value of the target gain have been disclosed. Such techniques can also be combined with each other, to form further options.

Techniques are available in the prior art to determine the phase shift values to achieve respective beam patterns as illustrated in FIGS. 6 through 10. It would be possible to employ a codebook approach. Here, a predetermined codebook can be used that lists candidate phase shift values for different values of the target input direction, target output direction, and target gain. I.e., the codebook can include entries that specify for each target input direction, target output direction, as well as each value of the target gain which phase shift values to use; thereby, providing instructions on how to construct the beams illustrated and discussed above. The architecture of the codebook is represented by the example of TAB 2.

TABLE 2
Example structure of a codebook resolving for different output directions via beam iden-
tity and further resolving for different values of the target gain. As a general rule, more than two
beams can be resolved in more than three values of the target gain can be resolved.
Summarizing, techniques have been disclosed that enable a variable gain provided by a CED.
This is achieved by determining the phase shift values for beamforming at least partly based on
a value of a target gain. In particular, a deliberate mismatch of the phase shift values with re-
spect to optimum phase shift values that would maximize the gain is used. The value of the tar-
get gain is accordingly selected from a range that is limited, at its upper end, by a maximum
value (this could be the nominal value of the gain achievable by the array gains and the gain of
the fixed-gain amplifier). The value of the target gain can be set smaller than the maximum
value.

| BEAM IDENTITY | | |
|---|---|---|
| (DEFINED BY OUT- | VALUE OF | PHASE SHIFT VALUES FOR ALL PHASE |
| PUT DIRECTION) | TARGET GAIN | SHIFTERS |
| Beam identity 1 η = 0° | Target gain = MAX | $( \begin{matrix}{β}_{2} \\ … \\ {β}_{M}\end{matrix} ) = ( \begin{matrix}{x}_{12 , MAX} \\ … \\ {x}_{1 M , MAX}\end{matrix} ) \neq ( \begin{matrix}{x}_{12 , LOW} \\ … \\ {x}_{1 M , LOW}\end{matrix} )$ |
| Beam identity 1 η = 0° | Target gain = MID | $( \begin{matrix}{β}_{2} \\ … \\ {β}_{M}\end{matrix} ) = ( \begin{matrix}{x}_{12 , MID} \\ … \\ {x}_{1 M , MID}\end{matrix} ) \neq ( \begin{matrix}{x}_{12 , MAX} \\ … \\ {x}_{1 M , MAX}\end{matrix} )$ |
| Beam identity 1 η = 0° | Target gain = LOW | $( \begin{matrix}{β}_{2} \\ … \\ {β}_{M}\end{matrix} ) = ( \begin{matrix}{x}_{12 , LOW} \\ … \\ {x}_{1 M , LOW}\end{matrix} ) \neq ( \begin{matrix}{x}_{12 , MID} \\ … \\ {x}_{1 M , MID}\end{matrix} )$ |
| Beam identity 2 η = 45° | Target gain = MAX | $( \begin{matrix}{β}_{2} \\ … \\ {β}_{M}\end{matrix} ) = ( \begin{matrix}{x}_{22 , MAX} \\ … \\ {x}_{2 M , MAX}\end{matrix} ) \neq ( \begin{matrix}{x}_{22 , LOW} \\ … \\ {x}_{2 M , LOW}\end{matrix} )$ |
| Beam identity 2 η = 45° | Target gain = MID | $( \begin{matrix}{β}_{2} \\ … \\ {β}_{M}\end{matrix} ) = ( \begin{matrix}{x}_{22 , MID} \\ … \\ {x}_{2 M , MID}\end{matrix} ) \neq ( \begin{matrix}{x}_{22 , MAX} \\ … \\ {x}_{2 M , MAX}\end{matrix} )$ |
| Beam identity 2 η = 45° | Target gain = LOW | $( \begin{matrix}{β}_{2} \\ … \\ {β}_{M}\end{matrix} ) = ( \begin{matrix}{x}_{22 , LOW} \\ … \\ {x}_{2 M , LOW}\end{matrix} ) \neq ( \begin{matrix}{x}_{22 , MID} \\ … \\ {x}_{2 M , MID}\end{matrix} )$ |

One option to mismatch the phase shift values is to select a fraction of them to have random values.

A further option is to perform a beam split at an antenna array of the CED, where parts of the signal are transmitted in a direction where it is known that there is no device. Thus, the output antenna array can be partitioned into multiple subarrays. One subarray serves the receiving communication device; while the other subarray defines a waste beam. As an example, one can transmit in a direction parallel to the antenna array (this would be the floor or the roof for a wall-mounted CED). As standard antenna elements have poor propagation characteristics in such directions, this would in practice imply that no signal is actually transmitted in said direction.

Such beam split is not only possible for the output antenna array, but alternatively or additionally also for the input antenna array. One of the subarrays can serve the transmitting communication device; while in other subarray can define a waste beam. The waste beam could again be aligned with the floor or the roof, for a wall-mounted CED. This would in practice imply that nothing is received since the antenna elements have poor characteristics in said directions.

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.

For illustration, above scenarios have been disclosed in connection with an implementation of the CED by a network-controlled repeater where all signals obtained at an input antenna array are combined at a combining node to a single signal that is then amplified by a fixed-gain amplifier (cf. FIG. 3). However, similar techniques can be readily employed for an implementation of the CED by a reconfigurable relaying device: here, the signals of the antenna elements of the input antenna array are not combined to a single signal; rather, each signal of an antenna element of the input antenna array is fixedly coupled to a respective antenna element of the output antenna array, via a respective fixed-gain power amplifier. Thus, there are multiple fixed-gain power amplifiers. Furthermore, techniques have been illustrated for scenarios where separate input and output antenna arrays are used. However, similar techniques may be employed for reconfigurable reflective devices; here, the input antenna array and the output antenna array are the same (reflective configuration); each antenna element includes a separate fixed-gain amplifier. Two example configurations of such reconfigurable reflective device are shown in FIG. 11 and FIG. 12. FIG. 11 illustrates how an array of antenna elements 500 is coupled to ground via phase shifters 561. Multiple fixed-gain amplifiers 551 are provided in-between the phase shifters 562 and ground. In FIG. 12 circulators 998 are used to provide a directed processing chain including—per antenna element 500—filter elements 999, the fixed gain amplifiers 551 and the phase shifters 551. For further illustration, various examples have been disclosed in connection with downlink communication from a BS of a cellular network to a UE. Similarly, the techniques disclosed herein can be employed for uplink communication from the UE to the BS. Further, it is not required to use integration into a cellular network. Also, other communications networks, e.g., Wi-Fi networks could benefit from the techniques disclosed herein.

For still further illustration, various examples have been disclosed in connection with a CED that employs a fixed-gain power amplifier. It would also be conceivable to employ the techniques disclosed herein, i.e., determining the phase shift values based on a value of the target gain, with a CED that includes a variable-gain power amplifier. Here, the dynamic gain range can be increased by combining the variable-gain power amplifier with phase shift value tuning of the gain.

1. A coverage-enhancing device, comprising:
an input antenna array comprising multiple first antenna elements and, for each one of the multiple first antenna elements, an associated first phase shifter,
at least one fixed-gain power amplifier,
an output antenna array coupled to the input antenna array via the at least one fixed-gain power amplifier and comprising multiple second antenna elements and, for each one of the multiple second antenna elements, an associated second phase shifter, and
a control circuitry configured to control the first phase shifters and the second phase shifters to apply phase shift values, wherein the control circuitry is configured to determine the phase shift values based on a value of a target gain.

2. The coverage-enhancing device of claim 1, wherein the control circuitry is configured to control the first phase shifters and the second phase shifters to apply first phase shift values for a first value of a target input direction and a first value of a target output direction and a first value of the target gain, wherein the control circuitry is configured to control the first phase shifters and the second phase shifters to apply second phase shift values for the first value of the target input direction and the first value of the target output direction and a second value of the target gain that is different than the first value of the target gain, wherein the first phase shift values are at least partly different than the second phase shift values.

3. The coverage-enhancing device of claim 2, wherein the first phase shift values are associated with a first received power along the first value of the target input direction, wherein the second phase shift values are associated with a second received power along the first value of the target input direction that is different than the first received power.

4. The coverage-enhancing device of claim 3, wherein the first phase shift values and the second phase shift values are associated with a different total received power.

5. The coverage-enhancing device of claim 2, wherein the first phase shift values are associated with a first radiated power along the first value of the target output direction, wherein the second phase shift values are associated with a second radiated power along the first value of the target output direction that is different than the first radiated power.

6. The coverage-enhancing device of claim 5, wherein the first phase shift values and the second phase shift values are associated with the same total radiated power.

7. The coverage-enhancing device of claim 5, wherein the first phase shift values and the second phase shift values are associated with a different total radiated power (TRP).

8. The coverage-enhancing device of claim 2, wherein both a first input beam defined by the first phase shift values and a second input beam defined by the second phase shift values are centered at the first value of the target input direction.

9. The coverage-enhancing device of claim 8, wherein the first input beam and the second input beam have the same beam width.

10. The coverage-enhancing device of claim 2, wherein both a first output beam defined by the first phase shift values and a second output beam defined by the second phase shift values are centered at the first value of the target output direction.

11. The coverage-enhancing device of claim 10, wherein the first output beam and the second output beam have the same output beam width.

12. The coverage-enhancing device of claim 1, wherein the control circuitry is configured to partition at least one of the multiple first antenna elements or the multiple second antenna elements into two or more subarrays, wherein said partitioning is based on the value of the target gain.

13. The coverage-enhancing device of claim 12, wherein the control circuitry is configured to randomize the phase shift values of at least one of the two or more subarrays.

14. The coverage-enhancing device of claim 12, wherein the control circuitry is configured to determine the phase shift values for a first one of the two or more subarrays to define a first beam, wherein the control circuitry is configured to determine the phase shift values for a second one of the two or more subarrays to define a second beam that is offset with respect to the first beam.

15. The coverage-enhancing device of claim 14, wherein an offset angle between the first beam and the second beam does not depend on the value of the target gain.

16. The coverage-enhancing device of claim 14, wherein the first beam is aligned with a value of a target input direction or a value of a target output direction associated with a communication device.

17. The coverage-enhancing device of claim 14, wherein the second beam has an elevation angle outside of −75° to +75°.

18. The coverage-enhancing device of claim 14, wherein the second beam is aligned with a target area configured by a control node of the coverage-enhancing device.

19. The coverage-enhancing device of claim 12, wherein a size of each one of the two or more subarrays is determined based on the value of the target gain.

20. The coverage-enhancing device of claim 12, wherein a relative arrangement of the two or more subarrays with respect to each other is determined based on the value of the target gain.

21-37. (canceled)
